(19) United States
(12) Patent Application Publication
(10) Pub. No.: US 2019/0189021 A1
(43) Pub. Date: Jun. 20, 2019

(54) STEM-CyLE: SCIENCE TECHNOLOGY ENGINEERING AND MATHEMATICS CYBERLEARNING ENVIRONMENT

(71) Applicants: Peter J. Clarke, Miami, FL (US); Raymond Chang Lau, Hialeah, FL (US); Steve Foo, Aventura, FL (US); Debra Davis, Miami, FL (US)

(72) Inventors: Peter J. Clarke, Miami, FL (US); Raymond Chang Lau, Hialeah, FL (US); Steve Foo, Aventura, FL (US); Debra Davis, Miami, FL (US)

(73) Assignee: The Florida International University Board of Trustees, Miami, FL (US)

(21) Appl. No.: 15/847,079

(22) Filed: Dec. 19, 2017

(51) Int. Cl. G09B 5/12; G09B 5/10; G09B 19/00; A63F 13/335; G09B 5/06; A63F 13/87

(52) U.S. Cl. CPC G09B 5/12; G09B 5/10; G09B 19/0053; A63F 13/87; A63F 13/335; G09B 5/06; G09B 19/0069

(57) ABSTRACT

Systems and method are provided for educational content and learning management systems. A system can include a computer-readable storage medium, a graphical user interface, an application programming interface, a communication link for connecting the computer-readable to at least one computing device. The medium can have instructions stored thereon and including learning objects, course materials, educational tutorials, virtual problem-based environments, and gamification elements.

### GOVERNMENT SUPPORT

This invention was made with government support under Award Number DUE-1225742 awarded by the National Science Foundation (NSF). The government has certain rights in the invention.

### BACKGROUND

Current classrooms utilize interactive educational software that permits teachers and students to engage in instructional and self-learning exercises. Embedded learning and engagement strategies (ELESs) and digital learning objects (DLOs) can be leveraged to allow teachers to create a dynamic learning environment that can be modified to maximize a student's educational experience.

### BRIEF SUMMARY

Embodiments of the subject invention provide domain specific learning management systems that can be dynamically configured for a specific course by (1) selecting learning content contained in the environment, and (2) using various embedded learning and engagement strategies to support pedagogy. Embodiments of the subject invention provide educational content and learning management systems that enhance the learning experience for students through learning objects, course materials, educational tutorials, virtual problem-based environments, and gamification elements.

### BRIEF DESCRIPTION OF DRAWINGS

FIG. 1 shows a diagram illustrating a high level view of how courses can be instantiated from STEM-CyLE.

FIG. 2 shows a diagram of a possible hierarchical structure of the STEM-CyLE functionality.

FIG. 3 shows a diagram of a possible high-level architecture of the STEM-CyLE system.

FIG. 4 shows a diagram of a possible structure of the STEM-CyLE application layer.

FIG. 5 shows an image of a web based login and authentication page of the STEM-CyLE.

FIG. 6 shows an image of a web based page of a student dashboard of the STEM-CyLE.

FIG. 7 shows an image of a web based page class assignment page of the STEM-CyLE.

FIG. 8 shows an image of a web based paged of a class leaderboard of the STEM-CyLE.

FIG. 9 shows an image of a web paged forum page of the STEM-CyLE.

FIG. 10 shows an image of a web based general assignments page of the STEM-CyLE.

FIG. 11 shows an image of a web based assignment page of the STEM-CyLE.

FIG. 12 shows an image of a web based quiz page of the STEM-CyLE.

### DETAILED DESCRIPTION

Embodiments of the subject invention, hereinafter collectively known as the Science Technology Engineering and Mathematics Cyberlearning Environment (STEM-CyLE) provide a domain specific learning management system that can be dynamically configured for a specific course by (1) selecting learning content contained in the environment, and (2) using various embedded learning and engagement strategies to support pedagogy. There are two main concepts used in STEM-CyLE, which include embedded learning and engagement strategies (ELESs) and digital learning objects (DLOs).

A first concept used in STEM-CyLE can be embedded learning and engagement strategies (ELESs), which can include collaborate learning, gamification, problem based learning, and social interaction. Collaborative learning is a process in which two or more people can work in groups mutually searching for understanding, solutions, or meanings, or creating a product. Collaborative learning can promote several education goals, including: (1) involvement, as students are more involved in the learning process by interacting significantly more with other students and teachers; (2) cooperation and teamwork, as students working together are confronted with different views and will therefore need to resolve these differences and build consensus in their teams; and (3) civic responsibility, which encourages students to participate in shaping their ideas and values.

Gamification can apply game design elements and game playing mechanics to improve user experience and engagement with a system, which can be applied to an educational context. Importantly, gamification is not about adding “games” to a system. It is about taking elements commonly implemented in games that humans find fun and enjoyable, and applying those to other domains in a manner that promotes people's motivation for engaging in desired behaviors and increasing engagement.

Problem-based learning (PBL) is a student-centered approach to learning and instruction in which students tackle problems in small groups under the supervision of a tutor. PBL has the potential to significantly increase student performance in the classroom.

Social Interaction can be an approach that enhances knowledge acquisition via social activities, and more recently with the advent of the internet the use of Online Learning Communities (OLCs) found that social interaction within an online framework can help university students share experiences and collaborate on relevant topics. As such, social networks can act as a pedagogical agent, for example, with problem-based learning.

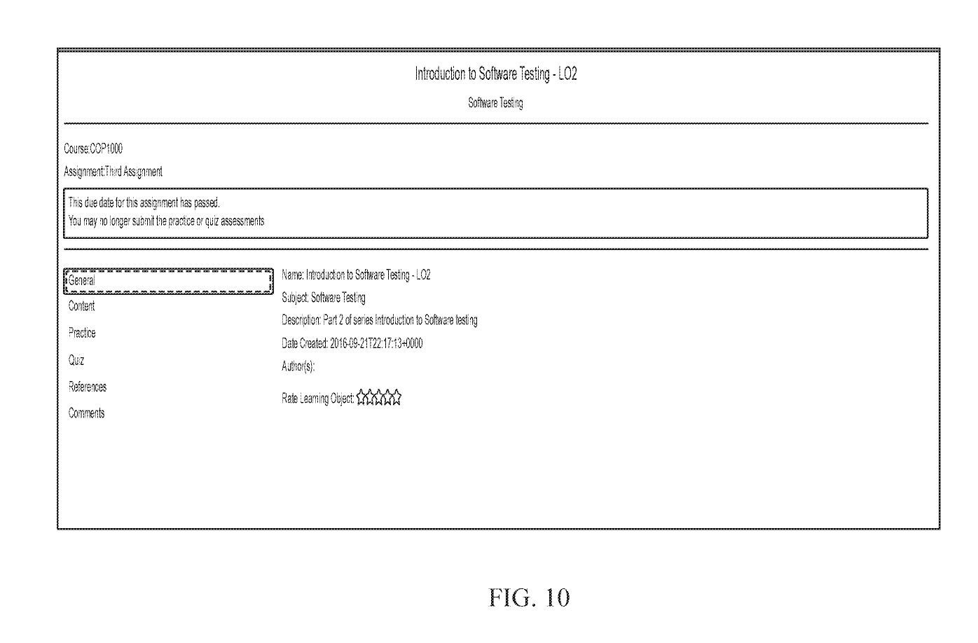

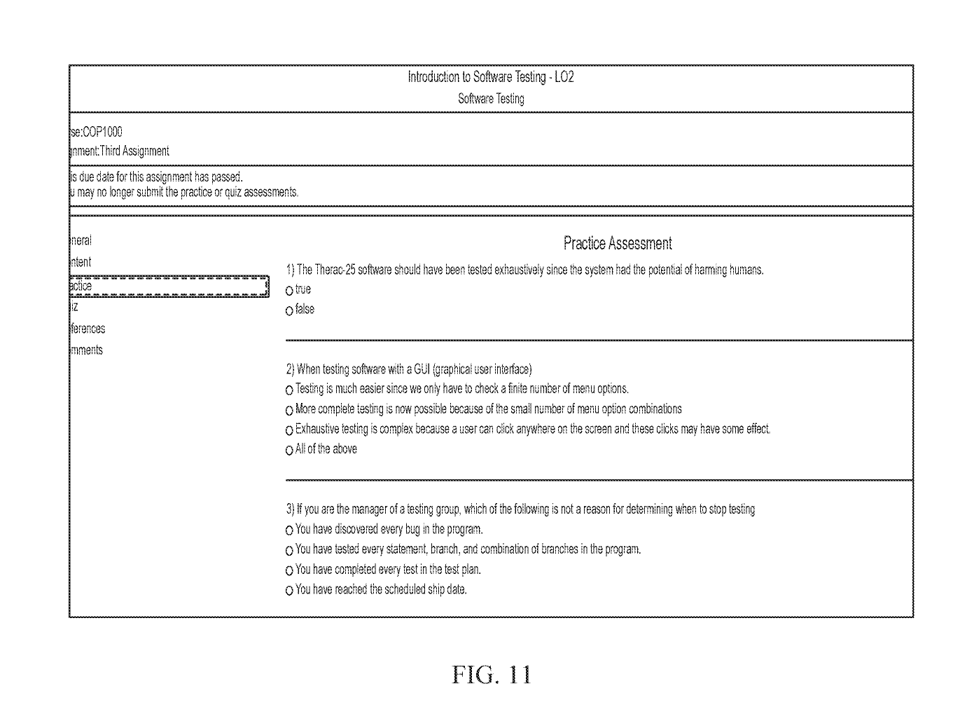

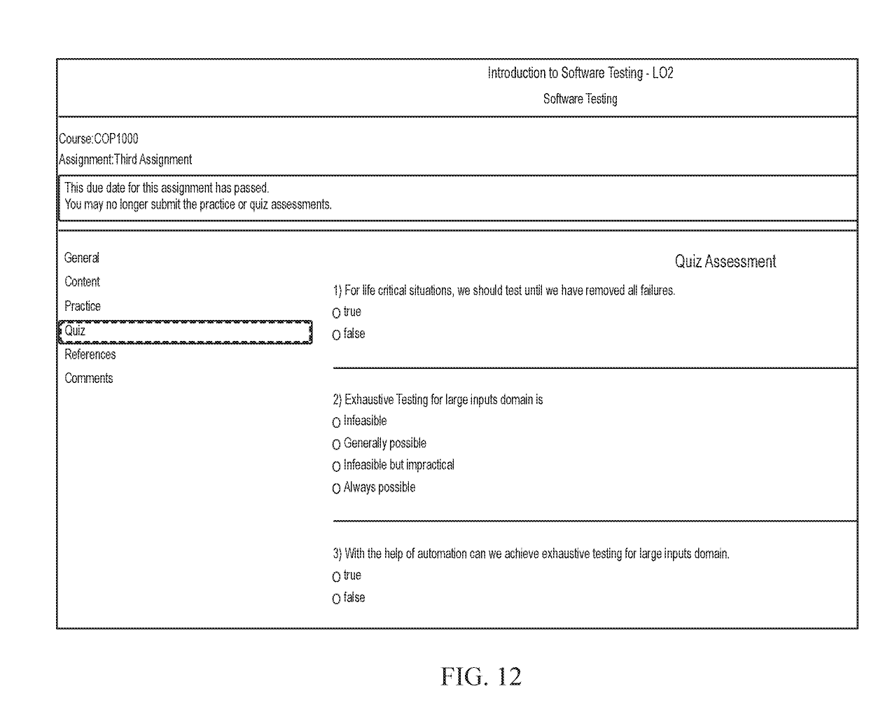

A second main concept in STEM-CyLE can be a Digital Learning Object (DLO). A learning object is any entity, digital or non-digital, that may be used for learning, education or training (IEEE Learning Technology Standards Committee (LTSC), 2002). Embodiments of the subject invention can restrict learning objects to the digital form (Digital Learning Objects, DLOs). DLOs can comprise a smaller amount of learning content than courses, modules or units; usually require between 2 to 15 minutes for completion; and are self-contained interactive, reusable and can be aggregated. Each LO can include four components: objective, content, practice, and assessment. The LO should address only one learning objective. The content or learning material contained in the LO focuses on that objective; Students have the opportunity to practice and review facts and key concepts using: exercises and/or quiz-type self-tests (see, for example, FIGS. 10-12). The LO can further assess whether the learner has achieved a stated learning objective.

Embodiments of the subject invention can permit students to move from the learning content module to a virtual problem-based environment (VPBE) in order to solve problems. For example, computer programming students may be asked to use the VPBE to write a program, run it, and answer a question.

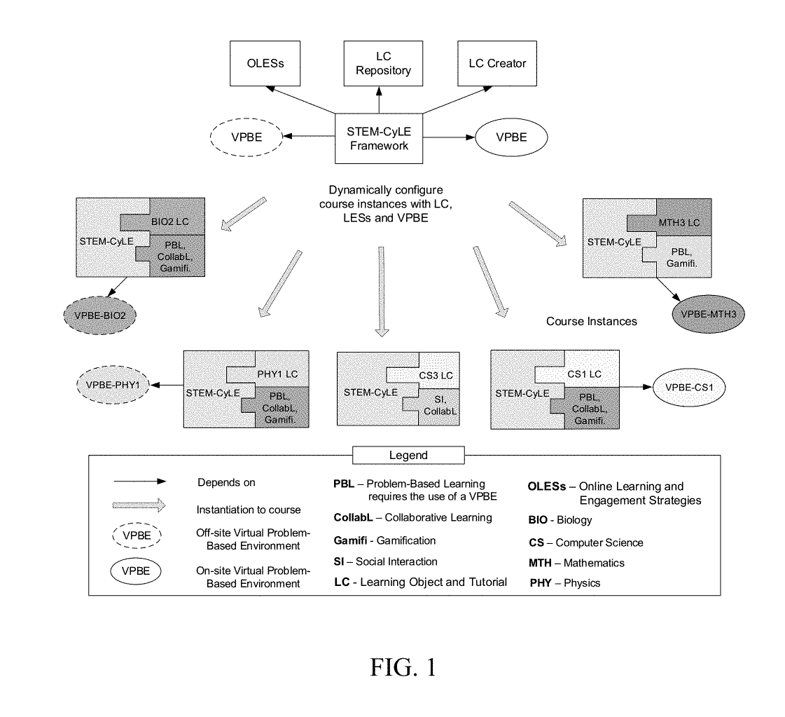

FIG. 1 illustrates a high level view of the how courses can be instantiated from STEM-CyLE. In certain embodiments, STEM-CyLE does not replace the current Learning Management Systems (LMSs) used in class, rather compliments current LMSs in a manner that is ubiquitous and transparent to the students by simply clicking a link in their current LMS and accessing the current course instance.

The top of FIG. 1 shows the STEM-CyLE framework that can be used to instantiate a course, possibly using one or more VPBEs. There are two types of VPBEs that can be used by STEM-CyLE: one that is hosted on the same server as STEM-CyLE, shown as a solid sphere in FIG. 1, such as a programming development environments running on a server, and one that is hosted at another site, shown as a dashed sphere in FIG. 1.

The system administrator can create instances of STEM-CyLE for each course (for example, biology (BIO), computer science (CS), mathematics (MTH), or physics PHY)) including access to unique features required for the related courses. These instances are shown on the second level of FIG. 1 using the oval and rectangle shapes. For example, the rectangle to the bottom right of FIG. 1 represents an instance of the CS 1 course that uses the problem-based learning (PBL), collaborative learning (Collabl), and gamification (Gamifi) ELEs. Since the problem-based learning ELES is used, the VPBE for CS can also be made accessible.

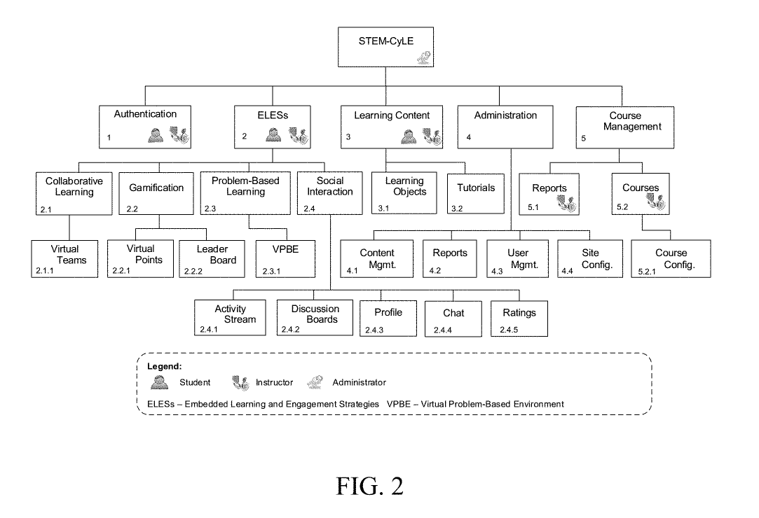

FIG. 2 shows a hierarchical structure of the STEM-CyLE functionality according to an embodiment of the subject invention. The functionality can include:

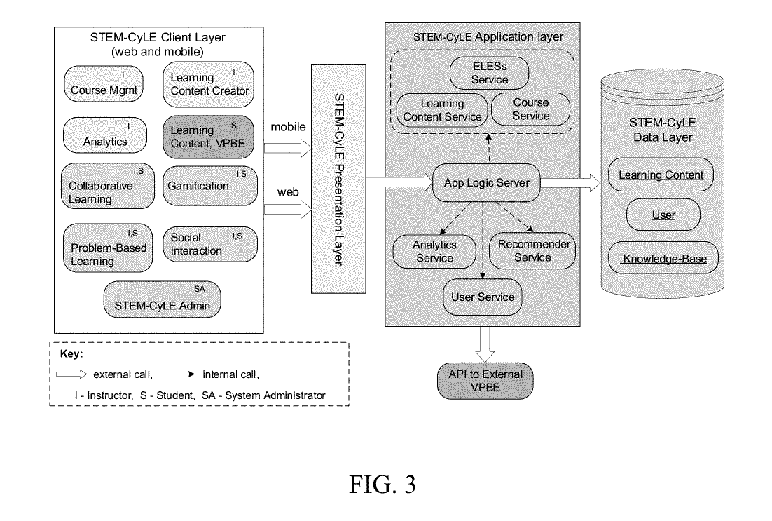

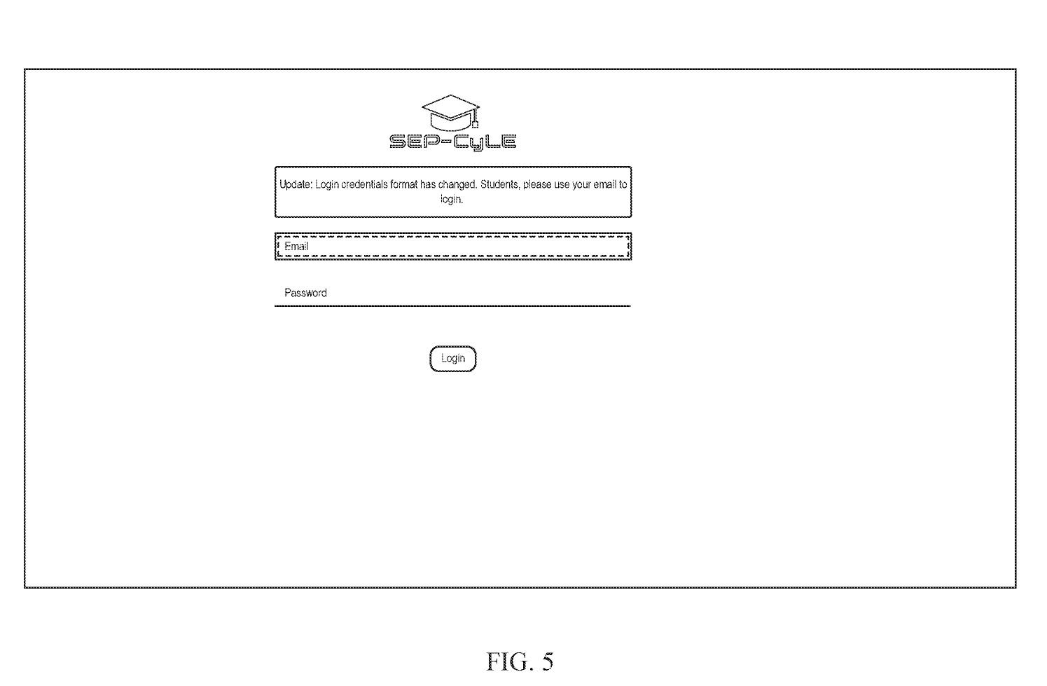

1. Authentication—to access the functionality shown in FIG. 3 all users can be required to logon and receive a security token (see, for example, FIG. 5).

2. Embedded Learning and Engagement Strategies (ELESs)—the following ELESs can be implemented in this component:

2.1. Collaborative learning—virtual teams can collaborate on various activities.

2.1.1. Virtual Teams—teams can collaborate to complete online assignments, post comments on the work of other teams. Teams can be awarded virtual points if gamification is used.

2.2. Gamification—this component can use virtual points along with game design elements and game mechanics to improve user experience and engagement. Gamification elements can include: (1) permitting students to choose an icon or avatar to represent the student in an online environment; (2) utilize a grading system that assigns grades through total points earned, (3) providing students with merit based rewards such as virtual badges or trophies, (4) encourage competition through virtual tournaments and challenges.

2.2.1. Virtual Points—points can be allocated for performing various activities, e.g.,

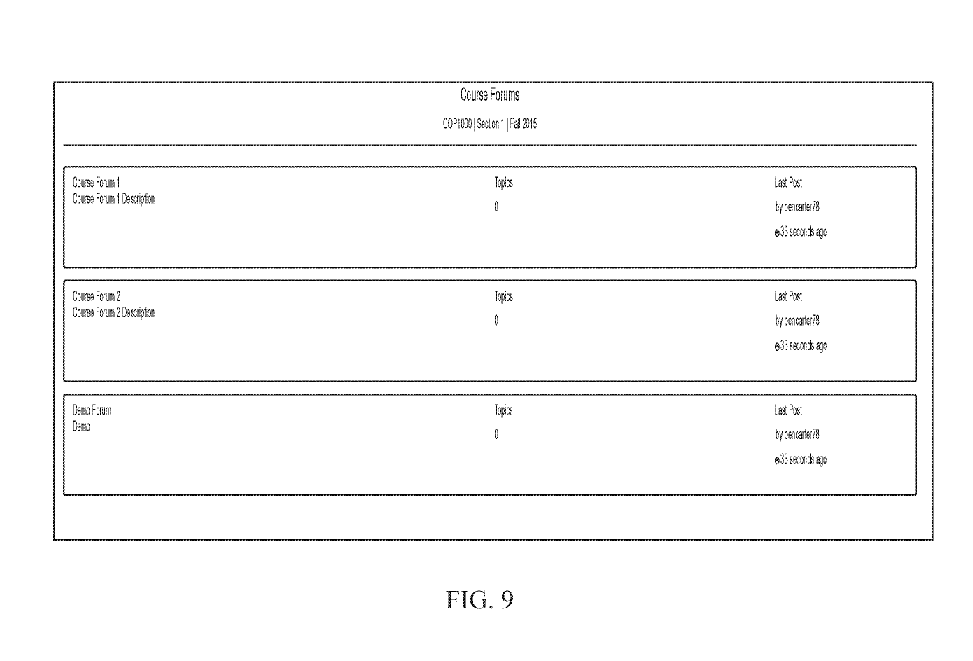

completing assignments, posting to a forum (see, for example, FIG. 9), completing a user profile, and posting helpful learning content that benefit others

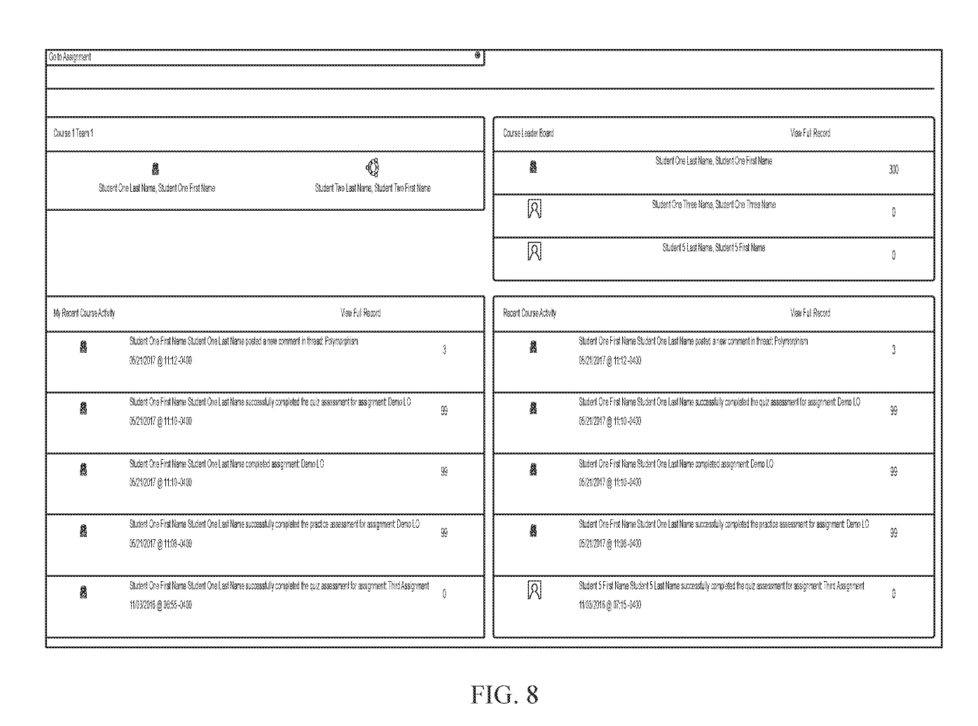

2.2.2. Leader Board—a leader board can be maintained for the entire class and seen by each student in the class (see, for example, FIG. 8).

2.3. Problem-based learning—problems can be solved using the virtual problem-based environments

2.3.1. Virtual Problem-Based Environment (VPBE)—interactive development

environments (IDE) or virtual laboratories that provide student the ability to solve problems can be used.

2.4. Social interaction—can include user profiles, message forums, group/individual chat, ratings and comment of learning content.

2.4.1. Activity Stream—can show activities that students are performing. This can be done on an individual basis as well as on a class-wide basis.

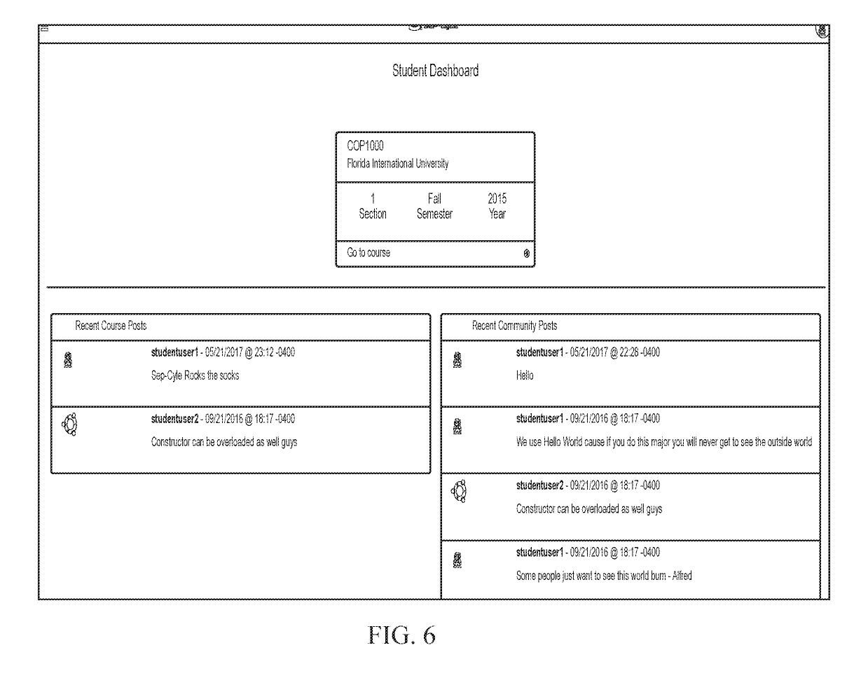

2.4.2. Discussion Boards—Instructors and students can post questions or comments on a class-wide forum as well as on a community-wide forum (see, for example, FIG. 6).

2.4.3. Profiles—can provide instructors and students with the ability to upload a picture and edit personal information, such as a password.

2.4.4. Chat—can provide students and the course instructor with the ability to have one-on-one or group communication. Also provides students in a team with the ability to perform chat in their respective teams.

2.4.5. Ratings—students can have the ability to rate the learning content and rate comments posted in the class forum or community forum.

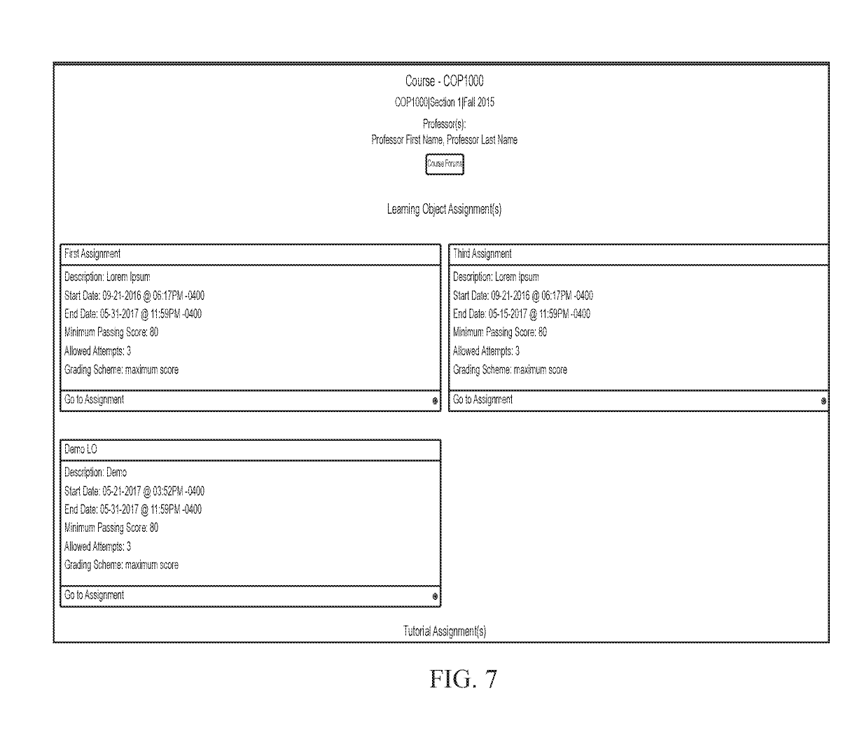

3. Learning Content—can represent the learning objects and tutorials available to the students (see, for example, FIG. 7).

3.1. Digital Learning Objects (DLOs)—entities that can be used for learning, education, or training. Based on the content of the LO, accessing the LO can also provide access to the VBPE.

3.2. Tutorials—are similar to the DLOs but do not necessarily have the evaluation section and may be longer than the learning objects.

4. Administration—can provide a mechanism for STEM-CyLE to be configured by an administrator.

4.1. Content Management—can provide the administrator with the ability to define the scope of the learning content accessible by the instructor in a course instance.

4.2. Reports—the reports component can provides STEM-CyLE with the ability to generate reports on how the system is being used, e.g., total number of users in the system, number of daily logins, number of course templates created, courses instantiated, numbers of users enrolled, and statistics on learning objects and tutorial usage, among others.

4.3. User Management—can provide the administrator with the ability to add users to the system, assign roles to the users block users and add institutions. These roles may include administrator, instructors, and student.

4.4. Site Configuration—can provide the administrator with the ability to enable courses with the facilities to support data collection for research. For example, providing student with a consent form, pretest and posttest data collection instruments.

5. Course Management—can provide instructors with the ability to configure and generate reports related to the course.

5.1. Reports—this component can allow the instructors to generate reports for students in each course either as an entire class or a single student. The student reports can be generated using data collected and processed by the analytics service of the system. The report includes performance on the learning objects, social interaction activities, and pre/posttest data collection instruments.

5.2. Courses—can provide the instructor access to configure the course.

5.2.1. Course Configuration—the instructor can select which learning and engagement strategies will be used in the course, set the virtual points, assign learning objects, and enable pre/posttest.

FIG. 3 shows a high-level logical architecture of the STEM-CyLE system according to an embodiment of the subject invention. STEM-CyLE can use a 4-tiered architecture providing access to both web and mobile clients, shown on the left side of FIG. 3. Requests from the clients are processed by a set of microservices that can be located in a STEM-CyLE Application server.

The client layer can provide users with interfaces to access the system using both mobile and web-based user interfaces. There can be three user roles: student (S), instructor (I), and system administrator (SA). A student can have access to the courses, learning content, discussion boards, and virtual points, among other features. An instructor can have access to the learning content creator, querying the system to generate various performance metrics generated by the system, and configuring the course instance with various combinations of ELESs, among other settings. A system administrator can configure the discipline instance and course instances.

The user interfaces in the client layer, as seen in FIG. 3, include the following: Course Management, which can provide an instructor with the ability to perform course management activities including: uploading student roles, assigning student teams, setting the upper limit for each category of virtual points, creating and editing course forums, assigning learning objects, assigning tutorials, and selecting which ELEs to assign to the course.

Learning Content Creator, which can provide an instructor with the ability to create and edit learning objects (LO) and tutorials. The LO creator can provide interfaces to enter data for LO details (name, subject, brief description, and author), learning content, practice quiz, real quiz, and references. The tutorial creator can provide the interface to enter data for tutorial details (name, description, and author), tool logo, training videos, URL links, and video links. The LO creator can also allow other instructors to review and provide feedback on newly created LOs before they are released to the community.

Analytics, which can provide an instructor with the ability to view student progress on LOs both in text and graphical form, average student performance on LOs, and projected student performance on LOs not yet assigned, as well as provide suggestions for those LOs a specific student should complete based on past performance.

Learning content and VPBE, which can provide a student with the ability to access the learning content on LOs and tutorials. Access can also be provided to the VPBE from the LOs and tutorials. All LOs and tutorials in the system can be accesses outside the course module but the grades for the LOs are not active. Only the scores for the quizzes of the assigned LOs in the course modules are recorded and based on the quiz scores are virtual points awarded. The VPBE can only be accessed using the STEM-CyLE credentials from inside STEM-CyLE. This interface also provides recommendations for the learning content students should complete based on their performance on completed LOs.

Collaborative Learning, which can provide an instructor with the ability to set up virtual teams for a given course. Students can be provided with the ability to work in teams, view the course activities of their team members, and use the group chat for communication purposes. When using the collaborative learning ELES, students can obtain bonus points when completing various activities in STEM-CyLE, such as, completing a LO first with respect to wall clock time and scoring above some predefined value on the quiz.

Gamification, which can provide an instructor with the ability to view/download the virtual points assigned to students in her/his courses through the various reporting mechanisms described in the analytics section. The student can be provided with the ability to (1) view their virtual points for each assigned LO and the total virtual points for the various activities in the course; (2) view the leaderboard for the course showing the top 5 students with the most virtual points in the class.

Problem-Based Learning, which can provide an instructor with the ability to (1) configure the VPBE for the course using the VPBE, and (2) access metrics associated with students' use of the VPBE, including time spent on tasks, percentage of correct exercises completed, and periodic snapshots of exercises being completed. For example the instructor can configure an Eclipse Che workspace which would include selecting the programming language, supporting libraries, and configure hardware requirements (RAM and disk space). Students can be provided with the ability to access and complete exercises (programming and modeling exercises for Eclipse Che) associated with LOs.

Social Interaction, which can provide an instructor with the ability to (1) monitor the activity stream for each student in her/his assigned courses, (2) manage discussion boards for the course, (3) update his/her profile, (4) manage the chat threads for a course, and (5) view ratings for all LOs and tutorials. The activity stream for each student can include a summary of activity, the time and date the activity was performed, and the virtual points that were allocated for that activity. A student can be provided with the ability to (1) view his/her activity streams, (2) view the course activity stream, (3) update his/her profile, (4) post to and view the course discussion boards, (5) chat with instructor or chat with team members, and (6) rate LOs and tutorials.

STEM-CyLE Admin, which can provides the system administrator with the ability to (1) configure the STEM-CyLE system including assigning roles to users, creating and editing course templates, creating and editing course instances, deleting users, creating and editing forums; (2) set up the configuration for the local virtual problem-based environment (VPBE); and (3) specify the usage and analytic metrics that can be accessible by instructors. Setting up the VPBE includes setting up the default parameters for instructors and students to access the VPBE. For example, for Eclipse Che the configuration would include setting up the default workspace which would include selecting the programming language, supporting libraries, and configure hardware requirements (RAM and disk space), and number of workspaces per virtual machine. The usage and analytic metrics can include the usage patterns of STEM-CyLE for a specified period of time, these patterns include total number of log ins for each category of user, the number of course template created, the number of course instances created, the number of times each LO was accessed, the number of times each tutorial was access, the average time spent on tasks (e.g., LOs and tutorials) for a specified set of students, rating for each LO, rating for each tutorial, number of posts on discussion boards, number of conversations on chat, and percentage of virtual points obtain for a set of students, among others.

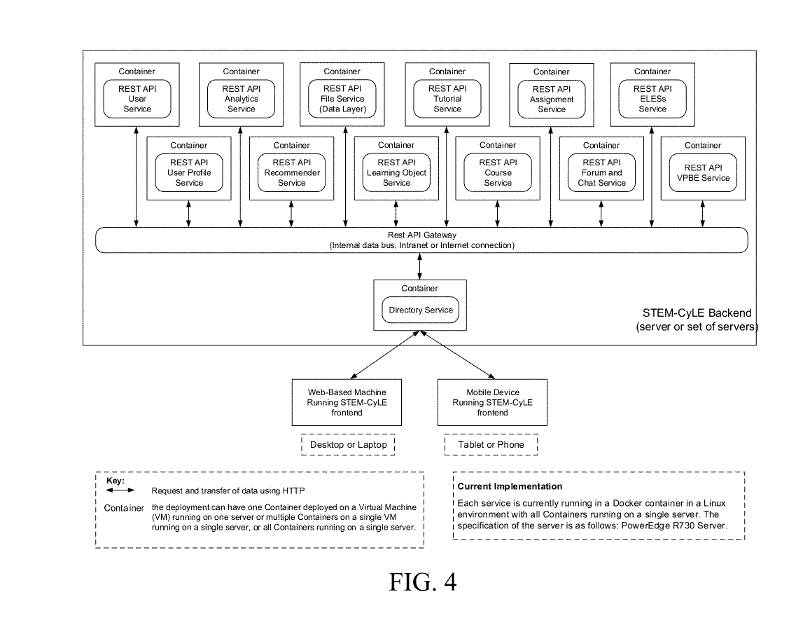

Regarding the Application Layer, the application logic server can process the request from the presentation layer and contains all the logic required to update the Data Server using six (6) major microservices (e.g., ELESs, Learning Content, Course, Recommender, Analytics, and User). FIG. 4 shows a more detailed structure of the STEM-CyLE application layer.

Embedded Learning and Engagement Strategies (ELESs) contain the functionality related to the ELESs (see, for example, Box 2 in FIG. 2) and uses other services. The ELES service uses the Course and Assignment services.

Learning Content is responsible for hosting the digital learning objects (DLOs) and tutorials (see, for example, Box 3 in FIG. 2). This microservice has access to the DLO and tutorial creator where instructors can create learning material that is then peer reviewed before being made available in the repository that stores the learning content. The learning content service comprises of a tutorial service, an assignment service, a Course service, and a learning object service, as seen in FIG. 4.

The Course service can contain all the functionality related to course management (see, for example, Box 5 in FIG. 2). The Course service can use the Assignment service and the forum and chat service, as seen in FIG. 4.

The Analytics service is a microservice that can generate student performance metrics based on queries submitted by the instructor. The data collected by the various other micro-services used to support the various models (user knowledge, user behavior, and user experience) can include: student responses to the practice and actual LO quizzes, number of time quizzes completed, time spent on tasks, LO pages reviewed after practice quiz, results of online surveys and questionnaires, demographic data, feedback provided by students per LO and tutorial (rating and comments), number of discussion board posts per student, number of chat entries in team chat, number of times a student views the activity stream, number of times a student views leader boards, and number of times a student views her/his virtual points, among others.

The Recommendation service is a microservice that can use a student's performance to recommend learning content the student should review before moving on. The Recommender service interacts with the Analytics service. The Recommender service follows a hybrid recommendation algorithmic approach that can include: (1) a feature extraction model, (2) a preference-based model, and (3) a neighbor-interest-based model. The learning object metadata captured in the learning object creator can be used to create an ontology that that allows learning content to be semantically structured based on prerequisite knowledge required for more advanced concepts. The preference model can be created using the feedback provided by a user of the system, this feedback includes how learning content is presented, e.g., as text, audio/video (AV) clips, and a hybrid of text and AV, among others. The neighbor-interest-based model can identify learners with similar profiles. These profiles can include a score on LOs, a rating of LOs, and the ELESs that are used when the LOs were completed. Based on a combination of the three models students can be recommended LOs and Tutorial to complete.

The Application Programming Interface (API) to third party systems, is a microservice that instantiates a connection to a VPBE. The API can provide STEM-CyLE with the ability to retrieve the following data including, but not limited to, time spent on tasks, percentage of correct exercises completed, list of completed exercises, periodic snapshots of exercises completed, list of exercises not completed, and a snapshot of exercise where student got stuck or was unable to continue.

The Data Layer can contain the data models and relationship for the various data sets that are used by the application logic server. The data model can include at least the following tables: (1) a Learning Content table, which contains the content in learning objects, tutorials, quizzes, etc.; (2) a User table, which contains data on all the users of the system (students, instructors, administrators); and (3) a Knowledge-Base table, which contains the analytic data generated for the various system interactions, usage patterns, and student performance metrics, including usage patterns of STEM-CyLE for a specified period of time, these patterns can include a total number of log ins for each category of user, a number of course template created, a number of course instances created, a number of times each LO was accessed, a number of times each tutorial was access, the average time spent on tasks (e.g., LOs and tutorials) for a specified set of students, rating for each LO, a rating for each tutorial, a number of posts on discussion boards, a number of conversations on chat, and a percentage of virtual points obtain for a set of students, among others.

The STEM-CyLE software can be deployed on a server. To simulate a distributed computing environment (as is required for deployment of a microservices based software), STEM-CyLE uses open source technology to deploy and run each microservice described in FIG. 4 in separate logical computing units that behave as physically distributed servers.

The logical architecture for STEM-CyLE, as shown in FIG. 3, can be deployed using a set of microservices on an Intel Xeon server platform. The server currently uses two octo-core Intel® Xeon® CPU E5-2630 processors and 132 GB of RAM. To simulate a distributed computing environment (as is required for deployment of a microservices based software), STEM-CyLE can use Docker to deploy and run each microservice as shown in FIG. 4. Each microservice can be implemented as a container image which is “is a lightweight, stand-alone, executable package of a piece of software that includes everything needed to run it: code, runtime, system tools, system libraries, settings.

FIG. 4 shows the current deployment of the STEM-CyLE application using twelve (12) microservices on an Intel Xeon server platform. The microservices shown in FIG. 4 from left to right are as follows: User service, which can provide a user with the ability to log on to the system and based on the user's role return the appropriate pages. For each type of user, the pages returned to the user would provide that user with the functionality described above. This service can use the User Profile service.

User Profile service, which can provide a user with the ability to update his/her user profile, including changing the password, uploading a picture, and update user biography. This service can use the User and File services.

Analytics service, which can generate the usage and metric data described above. This service can use all of the other services to generate the appropriate metrics.

Recommender service, which, based on the combination of the three models previously described, can recommend additional LOs and tutorials the student should take before moving forward. The Recommender service can interact with the User and Analytics services.

File service, which can store the data generated from the other services. This service can use a database to store the data in several tables. The File service is a passive service and is invoked by the other services in the system.

Learning Object service, which can provide the user with the ability to create LOs; and store, edit and retrieve LOs using the User and File services.

Tutorial service, which can provide the user with the ability to create tutorials; and store, edit and retrieve tutorials using the User and File service.

Course service, which can provide the instructor with access to the various course management features as described above. The Course service can interact with all of the other services in FIG. 4, except VPBE service.

Assignment service, which can provide the instructor with the ability to assign LOs and tutorials to students. Note that based on the LOs and Tutorials assigned the VPBE may need to be invoked. The Assignment service can interact with the Course, LO, Tutorial and VPBE services.

Forum and Chat service, which is part of the social interaction feature. The Forum and Chat service can interact with the User service.

Embedded Learning and Engagement Strategies (ELESs) service, of which the features of the ELESs are described above. The ELESs service interacts with the Course, Assignment, Forum and Chat, and the VPBE services.

Virtual Problem-Based Environment (VPBE) service, of which the features of this service is described above. This service is a passive service and is activated for other services such as LO and Tutorial services.

The communication between the services, shown as the horizontal gateway that all the services interact with in FIG. 4, can use the Hypertext Transfer Protocol (HTTP) (W3C 2014). An embodiment of STEM-CyLE uses NGINX (NGINX Inc 2017) for service discovery and routing of synchronous service request. Asynchronous messaging between services is performed using RabbitMQ. STEMP-Cycle supports multiple messaging protocols.

The LESs in STEM-CyLE are configurable, that is, the instructor can select which LESs to use for a specific courses. Additionally, the STEM-CyLE 4 tiered architecture can include functionality, as seen in FIG. 3 and can be integrated with the microservices architecture (see, for example, FIG. 4). The microservices architecture support allows for improved software maintainability and better utilization of the server resources. STEM-CyLE has both a learning object creator and tutorial create to develop learning content.

STEM-CyLE provides an instructor with the ability to tune how the embedded learning and engagement strategies (ELESs) will be used in the classroom. This tuning of ELESs is expected to determine the optimal combination of ELESs that will maximize learning gains in the classroom. STEM-CyLE can provide a way of combining virtual problem-based environments into one system. STEM-CyLE can monitor the progress a student is making in completing assigned programming problems and assigned virtual points to the that students.

STEM-CyLE can also provide a framework for the educators to create digital learning content (both learning objects and tutorials) that can be store in a repository and used by other educators. STEM-CyLE can integrate into existing Learning Management Systems (LMSs) or also be used as a standalone system.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processer reads and executes the code and/or data stored on a computer-readable medium, the computer system and/or processer performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that is capable of storing computer-readable information/data. Computer-readable media should not be construed or interpreted to include any propagating signals. A computer-readable medium of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

The subject invention includes, but is not limited to, the following exemplified embodiments.

### Embodiment 1

An educational content and learning management system, the system comprising:

a (non-transitory) machine-readable medium (e.g., a (non-transitory) computer readable storage medium) comprising instructions stored thereon;

a graphical user interface in operable communication with the machine-readable medium;

an application programming interface providing a connection between the graphical user interface and the machine-readable medium; and

a communication link for connecting the machine-readable medium to at least one computing device,

the stored instructions include learning objects, course materials, educational tutorials, virtual problem-based environments, and gamification elements.

### Embodiment 2

The system according to embodiment 1, the instructions when executed causing a processor to:

transmit the learning objects, the course materials, the virtual problem-based environments, and the educational tutorials to a computing device; and

combine the learning objects, the course materials, the virtual problem-based environments, and the educational tutorials with gamification elements.

### Embodiment 3

The system according to embodiment 1, the instructions when executed causing a processor to:

transmit the learning objects, the course materials, the virtual problem-based environments, and the educational tutorials to a plurality of computing devices;

combine the learning objects, the course materials, the virtual problem-based environments, and the educational tutorials with gamification elements;

provide an online environment for social interaction; and

provide an online environment for collaborative learning.

### Embodiment 4

The system according to embodiment 3, the processor further:

permitting a first group of users to collaborate in a first virtual team in order to complete an objective or an assignment.

### Embodiment 5

The system according to embodiment 4, the processor further:

permitting a second group of users to collaborate in a second virtual team in order to complete an objective or assignment; and

permitting the first virtual team to compete against the second virtual team.

### Embodiment 6

The system according to any of embodiments 1 or 3-5, the gamification elements being configured to include:

permitting a user to create an online user profile including at least one of a picture, an avatar, an icon, and personal information;

allocating points for performing various activities, including completing assignments, posting to a forum, completing a user profile, and posting learning content; and

transmitting a virtual leaderboard to the users displaying the users in descending or ascending order of points.

### Embodiment 7

The system according to any of embodiments 1 or 3-6, a virtual problem-based environment being configured to include:

an interactive development environments or virtual laboratories that provides the users the ability to solve problems.

### Embodiment 8

The system according to any of embodiments 1 or 3-7, a learning object being provided in digital format and including:

a single learning objective;

learning material focused on the objective;

facts and key concepts related to the objective;

exercises and/or quiz-type self-tests; and

assessment metrics on whether a user has achieved the stated learning objective.

### Embodiment 9

The system according to any of embodiments 1 or 3-8, the online environment for social interaction being configured to include:

permitting the users to create an user profile including at least one of a picture, an avatar, an icon, and personal information;

permitting the users to interact through a message forums, a group or an individual chat room;

permitting the users to provide a comments or a rating of the learning content;

providing an activity stream showing activities the users are performing;

providing a discussion board that allow the users to post a question or a comment; and

permitting students to communicate with an instructor in a private or public forum.

### Embodiment 10

The system according to any of embodiments 1 or 3-9, the processor further:

receiving a verification or security input identifying a particular user; and

restricting access to the system upon failure to provide verification or security input.

### Embodiment 11

The system according to any of embodiments 1 or 3-10, the processor further:

analyzing a user's performance metrics; and

providing learning content for user's to review based upon the user's performance metrics.

### Embodiment 12

The system according to any of embodiments 1 or 3-11, the processor further:

permitting an instructor to add, modify or delete the learning objects, the course materials, the virtual problem-based environments, and the educational tutorials.

### Embodiment 13

A method of providing educational and learning content, the method comprising:

transmitting learning objects, online course materials, virtual problem-based environments, and educational tutorials in electronic format to a plurality of students;

combining the learning objects, the course materials, the virtual problem-based environments, and the educational tutorials with gamification elements;

providing an online environment for social interaction; and

providing an online environment for collaborative learning.

### Embodiment 14

The method according to embodiment 13, further comprising:

permitting a first group of users to collaborate in a first virtual team in order to complete an objective or an assignment.

### Embodiment 15

The method according to embodiment 14, further comprising:

permitting a second group of users to collaborate in a second virtual team in order to complete an objective or assignment; and

permitting the first virtual team to compete against the second virtual team.

### Embodiment 16

The method according to any of embodiments 13-15, further comprising:

permitting the users to create an online user profile including at least one of a picture, an avatar, an icon, and personal information;

allocating points for performing various activities, including completing assignments, posting to a forum, completing a user profile, and posting helpful learning content that benefit others; and

transmitting a virtual leaderboard to the users displaying the users in descending or ascending order of points.

### Embodiment 17

The method according to any of embodiments 13-16, further comprising:

providing, by an interactive development environment or virtual laboratories, the users the ability to solve problems.

### Embodiment 18

The method according to any of embodiments 13-17, further comprising:

permitting the users to interact through a message forum, a group or an individual chat;

permitting the users to provide a comment or rating of the learning content;

providing an activity stream showing activities the users are performing;

providing an online discussion board that allow the users to post questions or comments; and

permitting the users to electronically communication with an instructor in a private or public forum.

### Embodiment 19

The method according to any of embodiments 13-18, further comprising:

analyzing a user's performance metrics;

providing learning content for the user to review based upon the user's performance metrics; and

adding, modifying or deleting the learning objects, the course materials, the virtual problem-based environments, and the educational tutorials based upon the user's performance metrics.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including those in the “References” section) are incorporated by reference in their entirety, including all figures and tables, to the extent they are not inconsistent with the explicit teachings of this specification.

### REFERENCES

[1] ATutor Development Team. (2016). ATutor Learning Management Tools. (http://www.atutor.ca/).
[2] Bienkowski, M., Feng, M. & Means, B. (2012). Enhancing Teaching and Learning Through Educational Data Mining and Learning Analytics: An Issue Brief. Retrieved from http://tech.ed.gov/wp-content/uploads/2014/03/edm-la-brief.pdf
[3] Blackboard Development Team. (2016). Blackboard. (http://www.blackboard.com).
[4] Capon, N., & Kuhn, D. (2004). What's So Good About Problem-Based Learning?Cognition and Instruction, 22, 61-79. Retrieved from http://www.tandfonline.com/doi/abs/10.1207/s532690Xci2201 3.
[5] Canvas Development Team. (2016). Canvas. (https://www.canvaslms.com/).
[6] Docker Development Team. (2016). Docker. (https://www.docker.com/).
[7] Dominguez, A., de Navarrete, J. S., de Marcos, L., Fernandez-Sanz, L., Pages, C., & Martinez-Herraiz, J.-J. (2013). Gamifying learning experiences: Practical implications and outcomes. Computers & Education, 63 (0), 380-392.
[8] Drupal Community. 2017. Drupal. Retrieved Jul. 15, 2017, from http://drupal.org/.
[9] Eclipse Foundation. (2017). Eclipse Che. Retrieved from http://www.eclipse.org/che/.
[10] Gijbels, D., Dochy, F., den Bossche, P. V., & Segers, M. (2005). Effects of problem-based learning: A meta-analysis from the angle of assessment. Review of Educational Research, 75 (1), 27-61. Retrieved from http://dx.doi.org/10.3102/00346543075001027.
[11] Hara, N., & Kling, R. (1999). Students' frustrations with a web-based distance education course. First Monday, 4 (12). (http://firstmonday.org/htbin/cgiwrap/bin/oj s/index.php/fm/article/view/710/620).
[12] IEEE Learning Technology Standards Committee (LTSC). (2002). IEEE standard for learning object metadata. IEEE Std 1484.12.1-2002, i-32 doi: 10.1109/IEEESTD.2002.94128.
[13] Iosup, A., & Epema, D. (2014). An experience report on using gamification in technical higher education. In Proceedings of the 45th acm technical symposium on computer scienceeducation (pp. 27-32). New York, N.Y., USA: ACM. Retrieved from http://doi.acm.org/10.1145/2538862.2538899.
[14] Koohang, A. (2004). Creating learning objects in collaborative e-learning settings. Issues in Information Systems, 4 (2), 584-590. Retrieved from http://www.iacis.org/iis/2004/Koohang.pdf.
[15] LESSEP (2017). Workshop on Using Learning and Engagement Strategies in Software Engineering and Programming Courses. https://stem-cyle.cis.fiu.edu/events.
[16] Liccardi, I., Ounnas, A., Pau, R., Massey, E., Kinnunen, P., Lewthwaite, S., Midy, M.-A. Sarkar, C. (2007, December). The role of social networks in students' learning experiences. SIGCSE Bull., 39 (4), 224-237. Retrieved from http://doi.acm.org/10.1145/1345375.1345442.
[17] Malone, T. W. (1980). What makes things fun to learn? heuristics for designing instructional computer games. In Proceedings of the 3rd acm sigsmall symposium and the first sigpc symposium on small systems. (pp. 162-169). New York, N.Y., USA: ACM.

Retrieved from http://doi.acm.org/10.1145/800088.802839.
[18] Moodle Development Team. (2016). Moodle. (https://moodle.org/).
[19] Newman, S. (2015). Building Microservices Designing Fine-Grained Systems. O'Reilly Media.
[20] PhET Development Team. (2016). PhET-Interactive Simulations for Science and Mathematics. Retrieved from https://phet.colorado.edu/en/simulations/category/physics.
[21] Schmidt, H. G. (1993). Foundations of problem-based learning: some explanatory notes. Medical Education, 27 (5), 422-432. Retrieved from http://dx.doi.org/10.1111/j.1365-2923.1993.tb00296.x.
[22] Smith, B. L., & MacGregor, J. T. (1992). What is Collaborative Learning? In A. Goodsell, M. Maher, & V. Tinto (Eds.), Collaborative learning: A sourcebook for higher education. University Park, Pa.: National Center on Postsecondary Teaching, Learning, and Assessment.
[23] Smith, R. S. (2004). Guidelines for authors of learning objects. The New Media Consortium. Retrieved from http://archive2.nmc.org/guidelines/NMCLOGuidelines.pdf.
[24] Talon, B., Leclet, D., Lewandowski, A., & Bourguin, G. (2009). Learning software testing using a collaborative activities oriented platform. In Proceedings of the 2009 ninth ieee international conference on advanced learning technologies (pp. 443{445). Washington, D.C., USA: IEEE Computer Society. Retrieved from http://dx.doi.org/10.1109/ICALT.2009.61 doi: 10.1109/ICALT.2009.61.
[25] Tsai, K. H., Chiu, T. K., Lee, C., & Wang, T. I. (2006). “A Learning Objects Recommendation Model based on the Preference and Ontological Approaches,” Sixth IEEE International Conference on Advanced Learning Technologies (ICALT'06), Kerkrade, pp. 36-40. doi: 10.1109/ICALT.2006.1652359
[26] W3C (2014) HTTP—Hypertext Transfer Protocol https://www.w3.org/Protocols/

1. An educational content and learning management system, the system comprising:
a non-transitory computer-readable storage medium comprising instructions stored thereon;
a graphical user interface in operable communication with the non-transitory computer-readable storage medium;
an application programming interface providing a connection between the graphical user interface and the non-transitory computer-readable storage medium; and
a communication link for connecting the non-transitory computer-readable to at least one computing device,
the stored instructions, when executed cause at least one processor to:
permit a system administrator to selectively populate respective instances of educational courses with at least one of learning objects, course materials, educational tutorials, virtual problem-based environments, collaborative learning elements, gamification elements, problem-based learning elements, and social interaction elements;
permit an educational course instructor to select which of the at least one of the learning objects, the course materials, the educational tutorials, the virtual problem-based environments, the collaborative learning elements, the gamification elements, the problem-based learning elements, and the social interaction elements, selected by the system administrator, is provided to a student of the educational course instructor;
assign a value of virtual points awarded to the student for each learning object; and
add, modify, or delete the learning objects, the course materials, the virtual problem-based environments, the gamification elements, the problem-based learning elements, and the social interaction elements, selected by the educational course instructor, for the student based upon a value of the student's virtual points,
each learning object comprising a single learning objective, learning material focused on the single learning objective of an educational course, facts and key concepts related to the single learning objective of an educational course, exercises and quiz-type self-tests, and assessment metrics on whether the student has achieved the single learning objective of the educational course,
each virtual problem-based environment being an interactive development environment or virtual laboratory that provides the student problems related to the educational course,
the gamification elements comprising an icon or avatar to represent the student in an online environment, a grading system that assigns grades through virtual points earned, merit based rewards such as virtual badges or virtual trophies, and a virtual tournament between students of an educational course,
the problem-based learning elements being configured to solve educational problems in the virtual problem-based environment,
the social interaction elements comprising a user profile, a discussion board, a group or individual chat room, and ratings or comments regarding a learning object, and
the educational content and learning management system further comprising: a plurality of containers respectively configured to implement a plurality of microservices corresponding to the learning objects, course materials, educational tutorials, virtual problem-based environments, collaborative learning elements, gamification elements, problem-based learning elements, and social interaction elements; and a gateway connected to the plurality of containers such that all of the microservices of the plurality of microservices interact with the gateway.

2. The system according to claim 1, the instructions when executed further causing the at least one processor to:
transmit the learning objects, the course materials, the virtual problem-based environments, and the educational tutorials, selected by the educational course instructor, to a computing device; and
combine the learning objects, the course materials, the virtual problem-based environments, and the educational tutorials, selected by the educational course instructor, with at least one of the collaborative learning elements, the problem-based learning elements, the social interaction elements, and the gamification elements, selected by the educational course instructor.

3. The system according to claim 1, the instructions when executed further causing the at least one processor to:
transmit the learning objects, the course materials, the virtual problem-based environments, and the educational tutorials, selected by the educational course instructor, to a plurality of computing devices;
combine the learning objects, the course materials, the virtual problem-based environments, and the educational tutorials, selected by the educational course instructor, with at least one of the collaborative learning elements, the problem-based learning elements, the social interaction elements, and the gamification elements, selected by the educational course instructor;
provide an online environment for social interaction,
the online environment for social interaction including at least one of a discussion board and a group or an individual chat room and
provide an online environment for collaborative learning and problem-based learning,
the online environment for collaborative learning and problem-based learning including at least one of a discussion board, a group or an individual chat room, and a virtual problem-based environment.

4. The system according to claim 3, the instructions when executed further causing the at least one processor to:
permit a first group of students to collaborate in a first virtual team in order to complete an objective or an assignment.

5. The system according to claim 4, the instructions when executed further causing the at least one processor to:
permit a second group of students to collaborate in a second virtual team to compete with the first virtual team on an objective or assignment.

6. The system according to claim 1, the gamification elements being configured to further include:
permitting a an educational course instructor, or a student to create an online user profile including at least one of a picture, an avatar, an icon, and personal information;
allocating virtual points for performing various activities, including completing assignments, posting to a forum, completing a user profile, and posting learning content; and
transmitting a virtual leaderboard to a plurality of students displaying respective user profiles in descending or ascending order of virtual points.

7-8. (canceled)

9. The system according to claim 3, the online environment for social interaction being configured to further include:
permitting a student to create a user profile including at least one of a picture, an avatar, an icon, and personal information;
permitting a plurality of students to interact through a discussion board or a group or an individual chat room;
permitting the student to provide a comments or a rating of learning content;
providing an activity stream showing activities the plurality of students are performing;
providing a discussion board that allow the plurality of students to post a question or a comment; and
permitting the plurality of students to communicate with an educational course instructor in a private or public forum.

10. The system according to claim 3, the instructions when executed further causing the at least one processor to:
restrict access to the system upon failure of a student to provide verification or security input.

11. (canceled)

12. The system according to claim 3, the instructions when executed further causing the at least one processor to:
permit an educational course instructor to add, modify or delete the learning objects, the course materials, the virtual problem-based environments, and the educational tutorials.

13. A method of providing educational and learning content, the method comprising:
transmitting learning objects, online course materials, virtual problem-based environments, and educational tutorials in electronic format to a plurality of students of an educational course;
combining the learning objects, the online course materials, the virtual problem-based environments, and the educational tutorials with collaborative learning, problem-based learning, social interaction, and gamification elements;
providing an online environment for social interaction, the online environment for social interaction including at least one of a discussion board and a group or an individual chat room;
providing an online environment for collaborative learning and problem-based learning, the online environment for collaborative learning and problem-based learning including at least one of a discussion board, a group or an individual chat room, and a virtual problem-based environment;
respectively implementing, in a plurality of containers of a server, a plurality of microservices corresponding to the learning objects, the online course materials, the educational tutorials, the virtual problem-based environments, the collaborative learning, the gamification elements, the problem-based learning, and the social interaction;
providing a gateway and allowing all microservices of the plurality of microservices to interact with the gateway;
permitting a system administrator to selectively populate respective instances of educational courses with at least one of learning objects, course materials, educational tutorials, virtual problem-based environments, collaborative learning elements, gamification elements, problem-based learning elements, and social interaction elements;
permitting an educational course instructor to select which of the at least one of the learning objects, the course materials, the educational tutorials, the virtual problem-based environments, the collaborative learning elements, the gamification elements, the problem-based learning elements, and the social interaction elements, selected by the system administrator, is provided to a student of the educational course instructor;
assigning a value of virtual points awarded to the student for each learning object; and
adding, modifying, or deleting the learning objects, the course materials, the virtual problem-based environments, the gamification elements, the problem-based learning elements, and the social interaction elements, selected by the educational course instructor, for the student based upon a value of the student's virtual points,
each learning object comprising a single learning objective, learning material focused on the single learning objective of an educational course, facts and key concepts related to the single learning objective of an educational course, exercises and quiz-type self-tests, and assessment metrics on whether the student has achieved the single learning objective of the educational course,
each virtual problem-based environment being an interactive development environment or virtual laboratory that provides the student problems related to the educational course,
the gamification elements comprising an icon or avatar to represent the student in an online environment, a grading system that assigns grades through virtual points earned, merit based rewards such as virtual badges or virtual trophies, and a virtual tournament between students of an educational course,
the problem-based learning elements being configured to solve educational problems in the virtual problem-based environment, and
the social interaction elements comprising a user profile, a discussion board, a group or individual chat room, and ratings or comments regarding a learning object.

14. The method of claim 13, further comprising:
permitting a first group of students to collaborate in a first virtual team in order to complete an objective or an assignment.

15. The method of claim 14, further comprising:
permitting a second group of students to collaborate in a second virtual team in order to complete an objective or assignment; and
permitting the first virtual team to compete against the second virtual team.

16. The method of claim 13, further comprising:
permitting a plurality of students to each create a respective online user profile including at least one of a picture, an avatar, an icon, and personal information;
allocating points for performing various activities, including completing assignments, posting to a forum, completing a user profile, and posting helpful learning content that benefit others; and
transmitting a virtual leaderboard to the plurality of students displaying the respective user profiles in descending or ascending order of points.

17. (canceled)

18. The method of claim 13, further comprising:
permitting a plurality of students to interact through;
permitting a student to provide a comment or rating of the learning content;
providing an activity stream showing respective activities that the plurality of students are performing;
providing an online discussion board that allow the users to post questions or comments; and
providing a group or an individual chat room for an educational course instructor and a student to communicate.

19. The method of claim 13, further comprising:
analyzing performance metrics of a student;
providing learning content for the student to review based upon the user's performance metrics; and
adding, modifying or deleting the learning objects, the course materials, the virtual problem-based environments, and the educational tutorials based upon the user's performance metrics.

20. An educational content and learning management system, the system comprising:
a non-transitory computer-readable storage medium comprising instructions stored thereon;
a graphical user interface in operable communication with the non-transitory computer-readable storage medium;
an application programming interface providing a connection between the graphical user interface and the non-transitory computer-readable storage medium; and
a communication link for connecting the non-transitory computer-readable storage medium to a computing device,
the stored instructions including a learning object, course materials, an educational tutorial, a virtual problem-based environment, and collaborative learning, problem-based learning, social interaction, and gamification elements,
the instructions when executed causing a processor to:
transmit the learning objects, the course materials, the virtual problem-based environments, and the educational tutorials to a plurality of computing devices;
combine the learning objects, the course materials, the virtual problem-based environments, and the educational tutorials with gamification elements;
provide an online environment for social interaction, the online environment for social interaction including at least one of a discussions board and a group or individual chat room;
provide an online environment for collaborative learning and problem-based learning, the online environment for collaborative learning and problem-based learning including at least one of a discussion board, a group or individual chat room, and a virtual problem based environment;
permit a first group of students in a first virtual team to compete with a second group of students in a second virtual team on an objective or an assignment;
permit a system administrator to selectively populate respective instances of educational courses with at least one of learning objects, course materials, educational tutorials, virtual problem-based environments, collaborative learning elements, gamification elements, problem-based learning elements, and social interaction elements;
permit an educational course instructor to select which of the at least one of the learning objects, the course materials, the educational tutorials, the virtual problem-based environments, the collaborative learning elements, the gamification elements, the problem-based learning elements, and the social interaction elements, selected by the system administrator, is provided to a student of the educational course instructor;
assign a value of virtual points awarded to the student for each learning object;
add, modify, or delete the learning objects, the course materials, the virtual problem-based environments, the gamification elements, the problem-based learning elements, and the social interaction elements, selected by the educational course instructor, for the student based upon a value of the student's virtual points,
each learning object comprising a single learning objective, learning material focused on the single learning objective of an educational course, facts and key concepts related to the single learning objective of an educational course, exercises and quiz-type self-tests, and assessment metrics on whether the student has achieved the single learning objective of the educational course,
each virtual problem-based environment being an interactive development environment or virtual laboratory that provides the student problems related to the educational course,
the gamification elements comprising an icon or avatar to represent the student in an online environment, a grading system that assigns grades through virtual points earned, merit based rewards such as virtual badges or virtual trophies, and a virtual tournament between students of an educational course,
the problem-based learning elements being configured to solve educational problems in the virtual problem-based environment,
the social interaction elements comprising a user profile, a discussion board, a group or individual chat room, and ratings or comments regarding a learning object, and
the educational content and learning management system further comprising: a plurality of containers respectively configured to implement a plurality of microservices corresponding to the learning objects, course materials, educational tutorials, virtual problem-based environments, collaborative learning elements, gamification elements, problem-based learning elements, and social interaction elements; and a gateway connected to the plurality of containers such that all of the microservices of the plurality of microservices interact with the gateway.

21. The educational content and learning management system according to claim 1, the educational course being physics, biology, mathematics, or computer science.

22. The method of providing educational and learning content according to claim 13, the educational course being physics, biology, mathematics, or computer science.

23. The educational content and learning management system according to claim 20, the educational course being physics, biology, mathematics, or computer science.
